(19) United States
(12) Patent Application Publication
(10) Pub. No.: US 2026/0177231 A1
(43) Pub. Date: Jun. 25, 2026

(54) PORTABLE AUTOMATIC DEPLOYING BEACON

(71) Applicant: Blue Force Gear, Inc., Pooler, GA (US)

(72) Inventors: Ashley A. Burnsed, JR., Savannah, GA (US); Stephen G. Hilliard, Charleston, SC (US)

(21) Appl. No.: 19/382,336

(22) Filed: Nov. 7, 2025

Related U.S. Application Data
(60) Provisional application No. 63/717,427, filed on Nov. 7, 2024.

(51) Int. Cl. F21V 21/14; F21V 19/00

(52) U.S. Cl. CPC F21V 21/145; F21V 19/001

(57) ABSTRACT

Described herein is a small, portable, light-emitting strobe beacon with a self-deploying tripod. The beacon may be stored within a holster on a belt or chest rig of a user (such as a law enforcement officer, for example) when not in use. The beacon may include a central member and a plurality of legs that are configured to automatically deploy (rotate outwardly relative to the central member) when the beacon is disposed within an environment. Each of the legs may include a hinge mechanism and a spring-loaded mechanism to facilitate the rotation of the legs relative to the central member.

### CROSS-REFERENCE TO RELATED APPLICATIONS

This application claims the priority benefit of Provisional U.S. Application No. 63/717,427, filed Nov. 7, 2024, which is incorporated herein, in its entirety, by reference.

### BACKGROUND

Law Enforcement officers and soldiers (and other users) require methods for quietly and passively communicating tactical movements, objectives, and cleared structure entry points. When multiple officers, agencies, or units arrive on scenes with active situations, lines of communication can break down. The overall chaos of such situations can make it difficult to identify areas of interest, entryways into structures that have been cleared of threats, or other notable positions, such as rally points.

### BRIEF DESCRIPTION OF THE DRAWINGS

FIG. 1A depicts a side perspective view of an embodiment of a portable beacon in a deployed position, in accordance with one or more embodiments of the disclosure.

FIG. 1B depicts a side view of the portable beacon of FIG. 1A in an undeployed position, in accordance with one or more embodiments of the disclosure.

FIGS. 2A-2B depict side views of another embodiment of a portable beacon in an undeployed position, in accordance with one or more embodiments of the disclosure.

FIG. 3 depicts a side perspective view of the portable beacon of FIGS. 2A-2B in a deployed position, in accordance with one or more embodiments of the disclosure.

FIG. 4 depicts a bottom perspective view of the portable beacon of FIGS. 2A-2B in a deployed position, in accordance with one or more embodiments of the disclosure.

FIG. 5 depicts a side view of a portion of the portable beacon of FIGS. 2A-2B, in accordance with one or more embodiments of the disclosure.

FIGS. 6A-6B depict a comparison between a side view of the portable beacon of FIG. 1A and the portable beacon of FIGS. 2A-2B.

FIGS. 7A-7B depict a comparison between a top view of the portable beacon of FIG. 1A and the portable beacon of FIGS. 2A-2B.

FIG. 8A depicts another side perspective view of the portable beacon of FIGS. 2A-2B in a deployed position, in accordance with one or more embodiments of the disclosure.

FIG. 8B depicts a side perspective view of the portable beacon of FIGS. 2A-2B in an undeployed position, in accordance with one or more embodiments of the disclosure.

FIG. 9 depicts an exploded view of the portable beacon of FIGS. 2A-2B, in accordance with one or more embodiments of the disclosure.

FIG. 10 depicts a close-up side view of a hinge mechanism of the portable beacon of FIGS. 2A-2B, in accordance with one or more embodiments of the disclosure.

FIG. 11 depicts an exploded view of the housing of the portable beacon of FIGS. 2A-2B, in accordance with one or more embodiments of the disclosure.

FIGS. 12A-12B depict an exploded view of the legs of the portable beacon of FIGS. 2A-2B, in accordance with one or more embodiments of the disclosure.

### DETAILED DESCRIPTION

Described herein is a small, portable, light-emitting diode (LED) strobe beacon with a self-deploying tripod. The beacon may be stored within a holster on a belt or chest rig of a user (such as a law enforcement officer, for example), when not in use. However, the beacon may also be stored in any other location. When it is desired for the beacon to be deployed (for example, during an active situation in which the user is involved), the user may remove the beacon from the holster and drop or otherwise provide the beacon in a desired location in the environment.

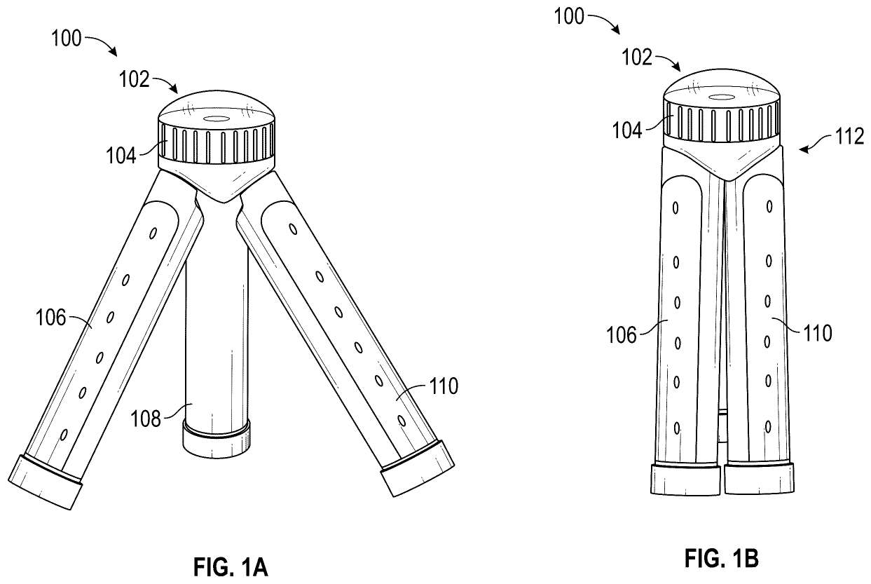

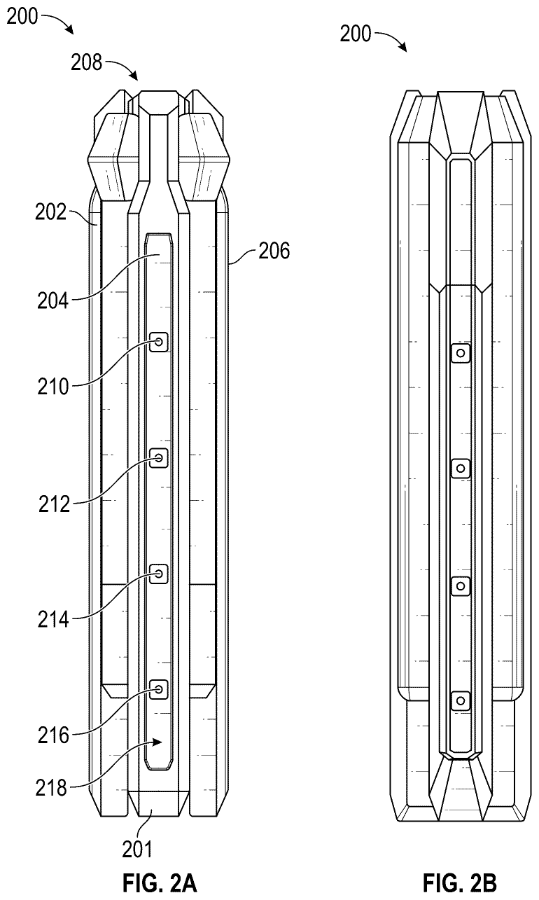

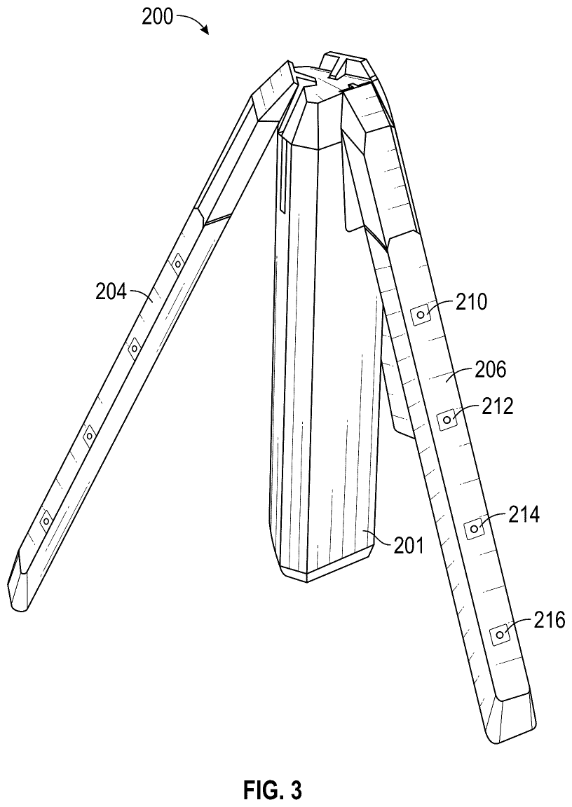

The beacon may be configured such that when the beacon is removed from the holster, the legs of the beacon may automatically deploy (spread outwardly from a central member of the beacon) from one another to form a base that allows the beacon to stand upright within the environment. For example, the beacon may include three individual legs (as shown in the figures). However, this is merely exemplary and the beacon may also include any other number of legs. One or more spring-loaded mechanisms may be provided within the beacon that naturally produce a force that pushes the legs apart from one another (referred to as a “deployed” configuration herein, and shown, for example, in at least FIGS. 1A and 3). Accordingly, when the beacon is removed from the holster and dropped in the environment, the forces produced by the spring-loaded mechanisms push the legs outward to automatically form the “tri-pod” configuration (in embodiments in which the beacon includes three legs), such that the beacon may then stand upright in the environment on the three legs. When it is desired to remove the beacon from the environment and add the beacon back to the holster, a force may be provided to push the legs back towards one another into a singular bundle (referred to as an “undeployed” configuration herein, and shown, for example, in at least FIGS. 1B and 2A-2B). For example, the user may squeeze the legs together using a force produced by the user's hand. The beacon may then be inserted back into the holster and the holster may maintain the legs in the singular bundle until the beacon is removed from the holster and placed down in the environment again.

Provided on top of the one or more legs may be one or more LEDs that may begin to strobe upon deployment of the beacon. The LED is merely one example of a type of element that may be used to produce a light and any other suitable type of light-emitting element may also be used (or a combination of different types of light-emitting elements). Accordingly, any reference to an LED hereinafter is not intended to be limiting and may instead refer to any other type of light-emitting element. The beacon may be battery powered and rechargeable and configured such that the beacon is durable in adverse environmental conditions and rough handling.

The beacon provides another option for users to provide non-verbal communications in chaotic engagements with suspects or other situations where quick identification of areas of interest is necessary. For example, upon arriving on scene in an active situation, a law enforcement officer could deploy beacons in cleared structure entryways, interior doors, or other areas of interest. These beacons could be easily communicated to other law enforcement officers that these areas are “safe” or “hot,” depending on the situation, and would be easily recognizable even with multiple departments or agencies responding. For example, the beacon may be configured to produce one color when the area is “safe” and a different color when the area is “hot” (this is merely an example and the beacon may be configured to provide this and other information in any other way). This communication would reduce confusion in situations where time to resolution is critical.

To selectively enable and disable the LEDs on the beacon (or other type of light-emitting elements), a magnetic dipswitch may be provided in the beacon and corresponding magnets may be provided in the one or more legs. When the beacon is removed from the holster and the legs separate, the magnets in the legs may separate from the magnetic dipswitch. This action releases the dipswitch, which may be connected to the LEDs or other electronic components in the beacon. The beacon may be configured such that when the magnetic dipswitch is disengaged, the LEDs are enabled. Likewise, when the magnetic dipswitch is engaged (when the legs are returned back to their initial position in a singular bundle), then the LEDs may be disabled. This may also apply to any other electrical components in the beacon. Additionally, it should be noted that this is merely one exemplary mechanism by which the electrical components of the beacon may be selectively enabled and disabled, and any other suitable mechanism may also be used. As another non-limiting example, the user may press a button or other type of element on the beacon to enable and disable the electrical components.

Additionally, the beacon may be configured to provide other types of signals other than light signals. For example, a global positioning system (GPS) antenna may be provided in the beacon that allows for location information to be communicated. The beacon may be configured to provide any other type of information as well. The beacon may also be configured to communicate with other devices using any suitable wired or wireless communication protocols. For example, a beacon may communicate with other beacons or may communicate with other devices, such as a smartphone of a user.

In embodiments in which the beacon is configured to communicate with a smartphone (or other type of device) of a user, an application may be installed on the device. The application may include a user interface that allows a user to view information produced by a beacon, such as status information the beacon is producing. The user interface may also allow the user to provide commands to the beacon, such as commands to change a color produced by the LED of the beacon (or any other type of command). The application therefore allows a user to view information about beacons that are not within the eyesight of the user (and control beacons that are not within the eyesight of the user).

Turning to the figures, FIGS. 1A-12 show various embodiments of a portable beacon as described herein. Specifically, FIGS. 1A-1B show a first embodiment of a portable beacon and FIGS. 2A-12 show a second embodiment of a portable beacon. It should be noted that the portable beacon is not necessarily limited to the specific configurations shown in FIGS. 1A-12, and variations in parameters, such as size, shape, etc. may also be possible.

Beginning with the first embodiments shown in FIGS. 1A-1B, FIG. 1A depicts a side perspective view of an embodiment of a portable beacon 100 in a deployed position. FIG. 1B depicts a side view of the portable beacon 100 of FIG. 1A in an undeployed position. The portable beacon 100 may include a housing 102 and one or more legs (the figure shows three legs, including legs 106-110, however, any other number of legs may be included). The housing 102 may include any other electronic components of the portable beacon 100, such as any LEDs, a GPS antenna, any control circuitry, a power source or power sources used to provide power to any of the electronic components, and/or other types of electronic components used to facilitate the functionality of a portable beacon as described herein. The legs serve as support structures for the portable beacon 100 such that when the portable beacon 100 is deployed in an environment, the portable beacon 100 remains upright in a stable position via the legs.

The portable beacon 100 may initially be stored in the undeployed position (shown in FIG. 1B). In this position, the legs are folded inward to provide a more compact form factor for the portable beacon 100 (to allow for easier storage of the portable beacon 100 when not in use). The portable beacon 100 may include spring-loaded mechanisms at the proximal end 112 of the legs that automatically deploy the legs when the portable beacon 100 is deployed in the environment. When not in use, the portable beacon 100 may be stored within another object, such as a holster, that counteracts the force of the spring-loaded mechanisms to prevent the legs from deploying when the portable beacon 100 is not in use (such that the portable beacon 100 remains in the undeployed position shown in FIG. 1B).

As indicated above, when it is desired for the portable beacon 100 to be deployed (for example, during an active situation in which the user is involved), a user may remove the portable beacon 100 from a holster (or other location where the portable beacon 100 is initially stored) and drop or otherwise provide the portable beacon 100 in a desired location in the environment. The portable beacon 100 may be configured such that when the portable beacon 100 is removed from its initial storage location, the legs of the portable beacon 100 may automatically deploy (spread out) from one another to form a base that allows the portable beacon 100 to stand upright within the environment.

In one or more embodiments, one or more spring-loaded mechanisms may be provided within the portable beacon 100 that naturally produce a force that pushes the legs apart from one another. Accordingly, when the beacon is removed from the holster and dropped in the environment, the force produced by the springs pushes the legs outward to automatically form the “tri-pod” configuration (in embodiments in which the beacon includes three legs), such that the beacon may then stand upright in the environment on the three legs. When it is desired to remove the portable beacon 100 from the environment and add the portable beacon 100 back into a storage location (such as a holster or any other type of storage location), a force may be provided to push the legs back towards one another into a singular bundle. For example, the user may squeeze the legs together using a force produced by the user's hand. The portable beacon 100 may then be inserted back into the holster, and the holster may maintain the legs in the singular bundle until the beacon is removed from the holster and placed down in the environment again.

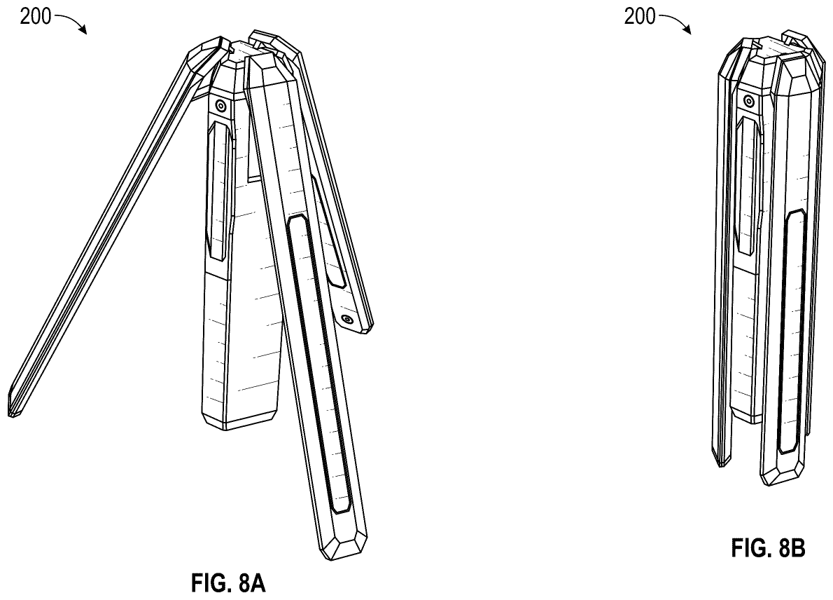

Turning to the second embodiment, FIGS. 2A-2B depict side views of another embodiment of a portable beacon 200 in an undeployed position. FIG. 8A depicts another side perspective view of the portable beacon of FIGS. 2A-2B in a deployed position. FIG. 8B depicts a side perspective view of the portable beacon of FIGS. 2A-2B in an undeployed position. Similar to the portable beacon 100 shown in FIGS. 1A-1B, the portable beacon 200 shown in FIGS. 2A-2B includes legs (such as legs 202-206). Although FIGS. 2A-2B show an embodiment in which the portable beacon 200 includes three legs, this is not intended to be limiting and the portable beacon 200 may include any other number of legs. FIGS. 2A-2B both show the portable beacon 200 in the undeployed position (similar to the undeployed position for the portable beacon 100 shown in FIG. 1B). Similar to the portable beacon 100, the portable beacon 200 may initially be stored in the undeployed position. In this undeployed position, the legs are folded inward to provide a more compact form factor for the portable beacon 200 (to provide for easier storage of the portable beacon 200 when not in use). The portable beacon 200 may also include spring-loaded mechanisms that automatically deploy the legs when the portable beacon 200 is disposed in the environment. However, this is not intended to be limiting and any other suitable mechanism may be used to automatically deploy the legs when the portable beacon 200 is disposed in the environment. When not in use, the portable beacon 200 may be stored within another object, such as a holster, that counteracts the force of the spring-loaded mechanisms to prevent the legs from deploying when the portable beacon 200 is not in use (such that the portable beacon 100 remains in the undeployed position shown in FIGS. 2A-2B).

In contrast with the portable beacon 100 shown in FIGS. 1A-1B, the portable beacon 200 shown in FIGS. 2A-2B does not include the housing at the top 208 of the portable beacon 200 (such as the housing 102 shown in FIGS. 1A-1B). Rather, the portable beacon 200 includes a central member 201, and the legs are located around the central member 201 and deploy outwardly from the central member 201.

Given that the portable beacon 200 does not include the housing, the LEDs may instead be provided on the outside and/or inside surfaces of the legs, as well as the central member 201. For example, FIG. 1A shows that the leg 204 includes four LEDs (LEDs 210-216) provided at intervals along an outer surface 218 of the leg 204. Although FIG. 2A shows the outer surface of the leg 204 as including four LEDs, this is not intended to be limiting and the leg 204 (or any other leg) may include any other number of LEDs. The LEDs may also be any other size and/or may be located at any positions along the outer surface 218 of the leg 204 (or the outer surface of any other leg). Although not shown in FIGS. 2A-2B, the portable beacon 200 may also include (or alternatively include) any number of LEDs on the inside surfaces of the legs. The LEDs may also (or alternatively) be included on any other surface of the portable beacon 200. Additionally, any additional electronic components (such as the GPS antenna, any control circuitry, a power source or power sources used to provide power to any of the electronic components, and/or other types of electronic components used to facilitate the functionality of a portable beacon as described herein) may be stored within the central member 201 and/or within any of the legs 204-208.

FIG. 3 depicts a side perspective view of the portable beacon 200 of FIGS. 2A-2B in a deployed position. As described above with respect to FIGS. 2A-2B, the portable beacon 200 may initially be provided in the undeployed position (shown in FIGS. 2A-2B), and may be maintained within the undeployed position by providing a force against the legs of the portable beacon 200. For example, as mentioned above, the portable beacon 200 may initially be held within a holster, or other type of structure that prevents the legs of the portable beacon 200 from expanding outwardly away from the central member 201. When it is desired to dispose the portable beacon 200 within an environment, the portable beacon 200 may be removed from the holster (or other type of structure) and placed within the environment. With the portable beacon 200 removed from the holster (or other type of structure), there is no longer an inward force counteracting the spring-loaded mechanisms of the legs, and the spring-loaded mechanisms force the legs to expand outwardly from the central member 201, as shown in FIG. 3. This results in the portable beacon 200 transitioning to the deployed position shown in FIG. 3 in which the portable beacon 200 can support itself upright in the environment via the legs (and/or the central member 201), given that the legs are arranged to form a “tri-pod” in the deployed position.

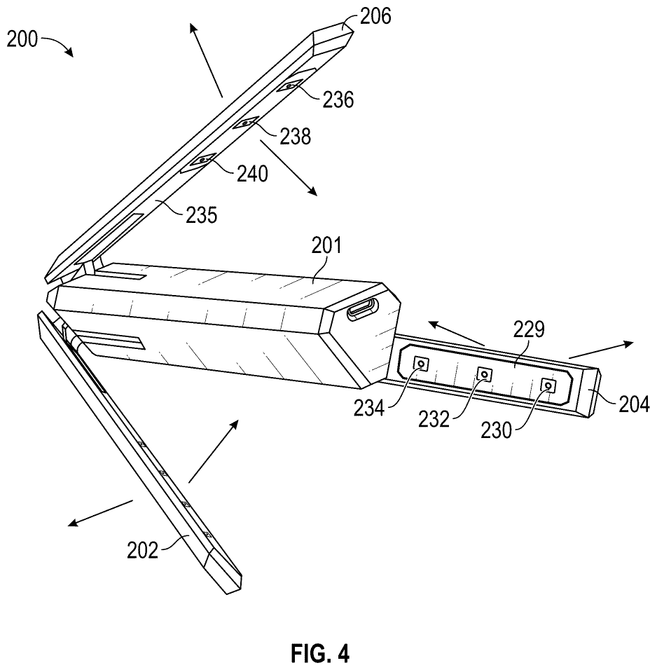

FIG. 4 depicts a bottom perspective view of the portable beacon 200 of FIGS. 2A-2B in a deployed position. In this perspective, LEDs on the inside surface of at least some of the legs are visible. For example, FIG. 4 shows that the inside surface 229 of the leg 204 includes LEDs 230-234, and that the inside surface 235 of the leg 206 includes LEDs 236-240. The inside surface of the leg 202 may similarly include one or more LEDs, however, these are not visible in the perspective shown in the figure. Although FIG. 4 shows the inside surfaces of the legs 204 and 206 as including three LEDs, this is not intended to be limiting, and the legs 204 and 206 (or any other leg) may include any other number of LEDs. The LEDs may also be any other size and/or may be located at any positions along the inside surfaces of the legs 204 and 206 (or the outer surface of any other leg).

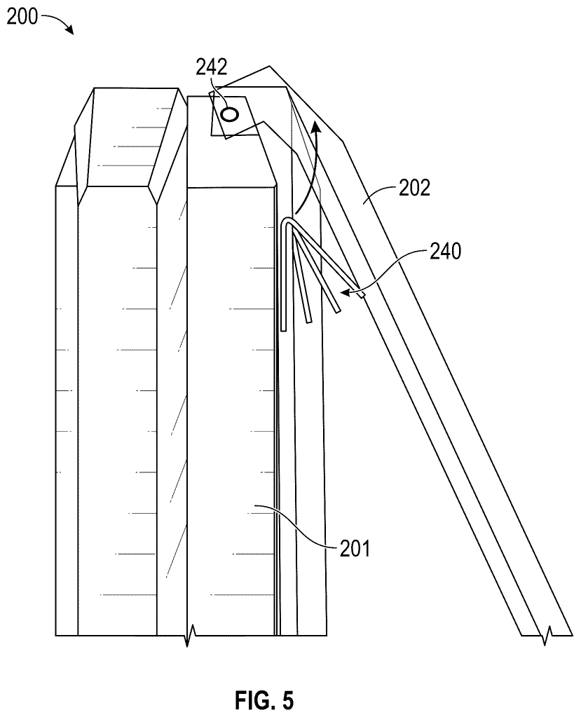

FIG. 5 depicts a side view of a portion of the portable beacon 200 of FIGS. 2A-2B. Specifically, FIG. 5 illustrates a close-up view of a spring-loaded mechanism 240 used to automatically cause a leg of the portable beacon 200 to rotate outwardly from the central member 201 of the portable beacon 200 when the portable beacon 200 is disposed within an environment. To facilitate the automatic transition of the leg 202 from an undeployed state (as shown in FIGS. 2A-2B) to a deployed state (as shown in FIGS. 3-4), the spring-loaded mechanism 240 may be configured to have its greatest potential energy (is under compression) when the leg 202 is in the undeployed state. Thus, without providing a counteracting force against the leg 202, the spring-loaded mechanism naturally produces a force that causes the leg 202 to rotate outwardly away from the central member 201. Although FIG. 5 shows only a single leg (leg 202) and spring-loaded mechanism 240, a similar spring-loaded mechanism may also be provided for any other legs of the portable beacon 200. The leg 202 may be configured to rotate about a hinge 242 that connects the leg 202 to the central member 201 (however, the leg 202 may be connected to the central member 201 using any other suitable mechanism that allows for a rotation of the leg 202 relative to the central member 201).

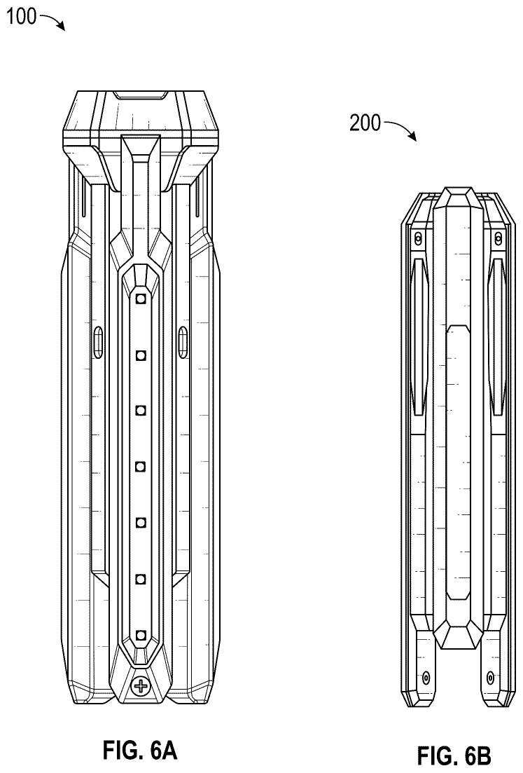

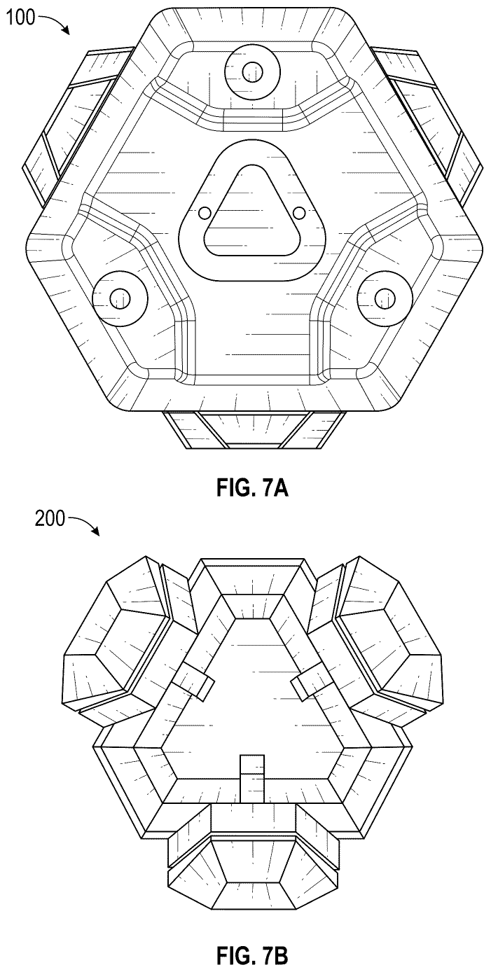

FIGS. 6A-6B depict a comparison between a side view of the portable beacon 100 of FIG. 1A and the portable beacon 200 of FIGS. 2A-2B. FIGS. 7A-7B depict a comparison between a top view of the portable beacon 100 of FIG. 1A and the portable beacon 200 of FIGS. 2A-2B. FIGS. 6A-6B and 7A-7B illustrate that the portable beacon 200 may be provided in a smaller form factor than the portable beacon 100 (at least in part because the portable beacon 200 does not include the housing 102). It should be noted that the exact sizes and shapes of each of the portable beacon 100 and portable beacon 200 shown in FIGS. 6A-6B and 7A-7B are merely illustrative and not intended to be limiting.

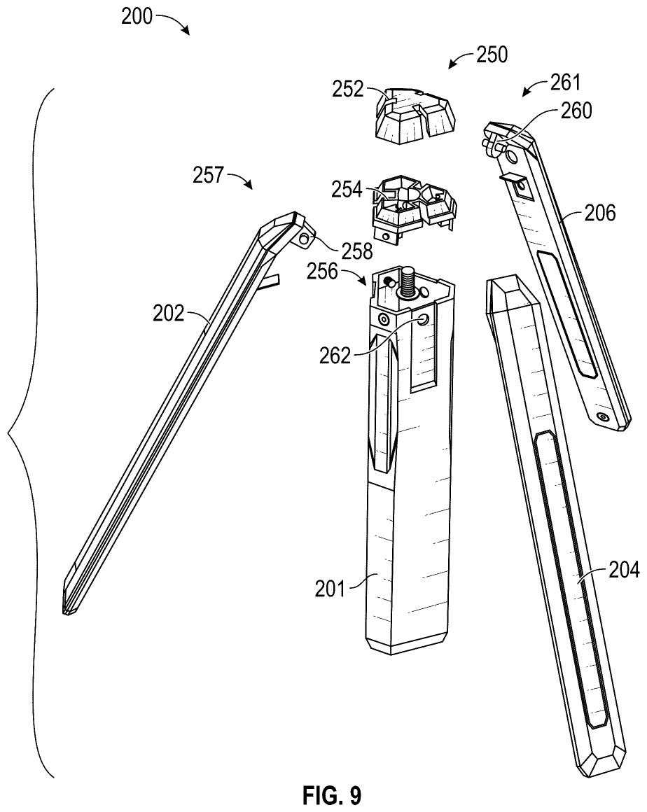

FIG. 9 depicts an exploded view of the portable beacon 200 of FIGS. 2A-2B. Particularly, FIG. 9 illustrates that the one or more legs of the portable beacon 200 (for example, legs 202-206 or any other number of legs) may be affixed to the central member 201 via a head assembly 250. In one or more embodiments, the head assembly 250 may include a base 254 and a cap 252. The base 254 may be removably or permanently affixed to a proximal end 256 of the central member 201, and the cap 252 may be removably or permanently affixed to the base 254. Although the head assembly 250 is shown as being comprised of two components, this is not intended to be limiting, and the head assembly 250 may be formed with any other number of components as well (for example, the head assembly 250 may be a single structure, may be made from three separate components, etc.).

Each of the legs may include hinge mechanisms that allow the legs to rotate outwardly away from the central member 201 (for example, using a spring-loaded mechanism as described above) when the portable beacon 200 is deployed for use in an environment. Specifically, FIG. 9 shows hinge mechanism 258 provided at the proximal end 258 of the leg 202 and hinge mechanism 260 provided at the proximal end 261 of leg 206 (leg 204 may also include a similar hinge mechanism, however, this feature is not visible in the perspective shown in FIG. 9). Each of the hinge mechanisms may be received by corresponding structure within the base 254 to allow the rotation of the legs relative to the base 254. Once the hinge mechanisms are received within the corresponding structures within the base 254, the cap 252 may be provided on the base 254 to secure the legs to the central member 201 at the hinge mechanisms. In some instances, the central member 201 may include one or more wire holes 262 for routing any wiring for electrical components within the central member 201 and/or any of the legs

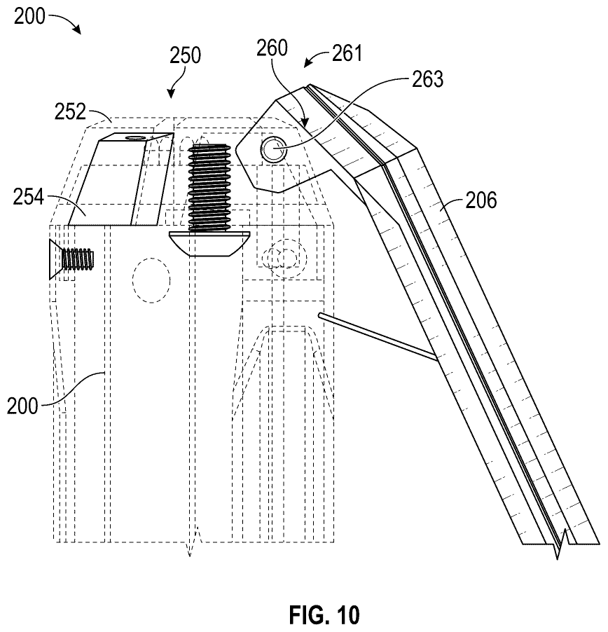

FIG. 10 depicts a close-up side view of a hinge mechanism 260 of the portable beacon 200 of FIGS. 2A-2B (that is, a close-up view of one of the hinge mechanisms shown in FIG. 9). Specifically, whereas FIG. 9 shows an exploded view in which the leg is not yet affixed to the central member 201 via the base 254, FIG. 10 illustrates the central member 201 with the head assembly 250 assembled, with the base 254 provided on the central member 201, the cap provided on the base 254, and the leg affixed to the head assembly 250 via the hinge mechanism 260. FIG. 10 shows that the hinge mechanism 260 may include one or more protruding pins 263 that extend outwardly from the hinge mechanism 260 in one or both directions. The base 254 may include a corresponding structure that is configured to receive the one or more protruding pins 263, which allows for a rotation of the one or more protruding pins 263 relative to this corresponding structure. Also shown in FIG. 10, the one or more protruding pins 263 may be held in place in the head assembly 250 by the cap 252. It should be noted that while FIGS. 9-10 provide one example of a type of structure that may be provided at the hinge mechanism 260 to allow for the rotation of the proximal end 261 of the leg 206 relative to the central member 201, this structure is merely exemplary and any other type of suitable structure may be used.

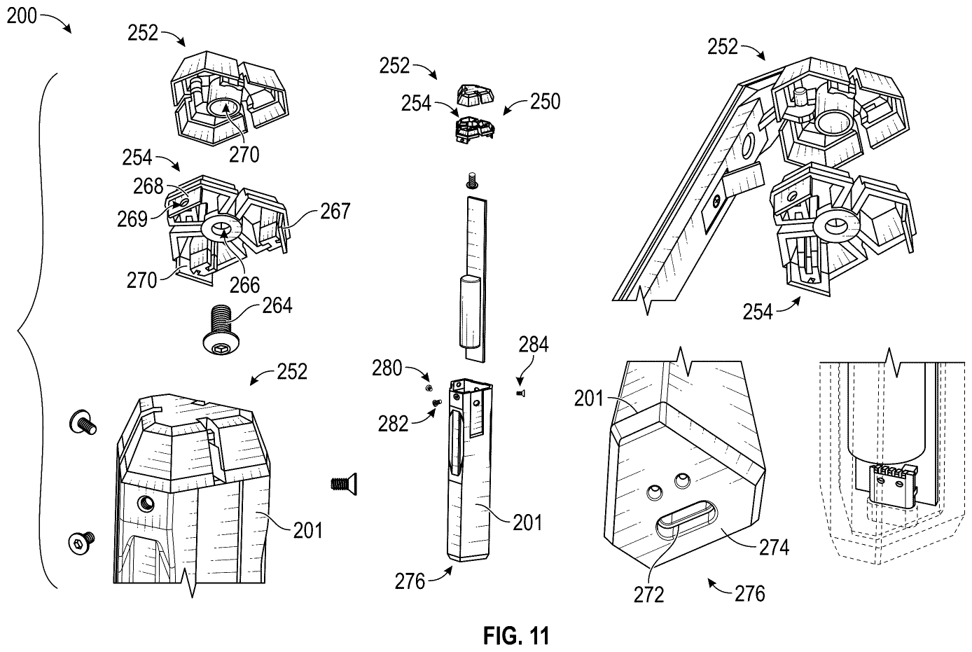

FIG. 11 depicts another exploded view of the portable beacon 200 of FIGS. 2A-2B. Particularly, FIG. 11 shows an exploded view of portions of the head assembly 250 shown in FIGS. FIG. 11 also shows further elements of the central member 201. Beginning with the head assembly 250, FIG. 11 shows that the cap 252 may be secured to the base 254 using a fastener 264 (such as a screw, as shown in the figure, or any other type of fastener). That is, the base 254 may include an aperture 266 and the cap 252 may include a corresponding aperture 270 that aligns with the aperture 266 when the cap 252 is positioned over the base 254. The fastener 264 may be inserted through both the aperture 266 and the aperture 270 to secure the cap 252 to the base 254. The interior surface of each of the apertures 266 and 270 may be threaded to receive the fastener 264. To allow for the base 254 of the head assembly 250 to be secured to the central member 201, the base 254 may include one or more tabs that extend downward at the outer edges of the base 254. For example, FIG. 11 shows tab 267, tab 268, and tab 270, however, this number of tabs is merely exemplary and the base 250 may include any other number of such tabs. Each of the tabs may include apertures configured to receive additional fasteners that are used to secure the base 254 of the head assembly 250 to the central member 201. The central member may include corresponding apertures that align with the apertures on the tabs of the base 254 when the base 254 is placed on the central member 201. Accordingly, when the base 254 is placed on the central member 201, the fasteners may be inserted through the apertures on the tabs of the base and the apertures on the central member 201 to secure the base to the central member 201. FIG. 11 shows three fasteners (e.g., fastener 280, fastener 282, and fastener 284). This is merely one example of a mechanism by which the base 254 may be secured to the central member 201 and any other suitable mechanism may be used instead.

Turning to the central member 201, FIG. 11 shows that a bottom surface 274 of the central member 201 located at a distal end 276 of the central member 201 may include a universal serial bus (USB) port 272 or any other type of port configured to receive a device (such as USB device) to facilitate data transfer to and/or from the portable beacon 200. For example, the portable beacon 200 may include a processor that is configured to control operations of any electronic components of the portable beacon 200. For example, the processor may control the operation of the LEDs (or any other light-emitting element) of the portable beacon 200, such as the intervals at which the LEDs are enabled, the duration of time the LEDs are enabled, etc. (in some cases, the LEDs may be continuously enabled as well). The USB port 272 (or any other type of port) may allow instructions to be provided to the processor to change the manner in which the LEDs are controlled (or to adjust the operation of the electronic components of the portable beacon 200 in any other suitable manner.

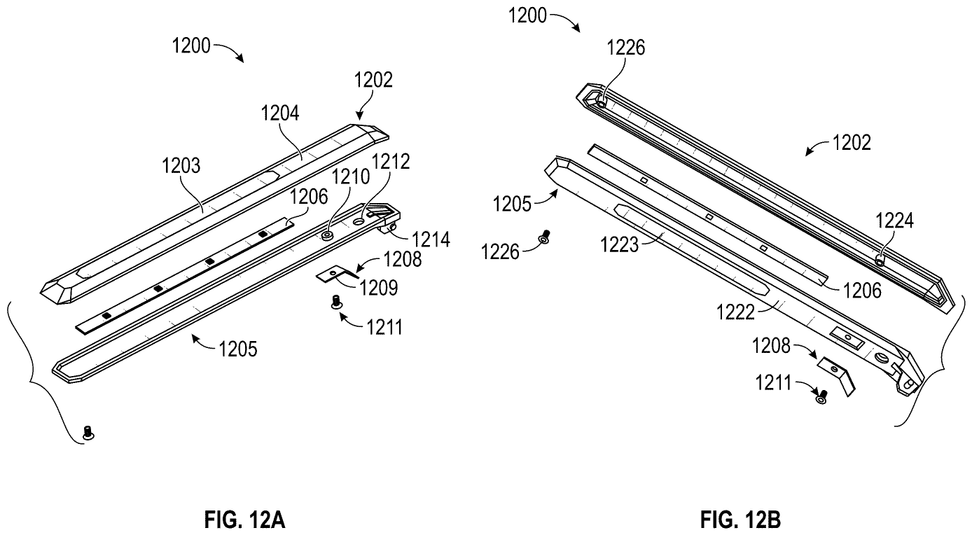

FIGS. 12A-12B depict exploded views of the legs of the portable beacon 200 of FIGS. 2A-2B. Specifically, FIG. 12A shows a top-down perspective exploded view of a leg 1200 (which may be the same as, or similar to, any of legs 202, 204, 206, etc.), and FIG. 12B shows a bottom-up perspective exploded view of the leg 1200. Beginning with FIG. 12A, the outer surface 1204 of the leg 1200 is shown (which may be the same as, or similar to, the outer surface of any other leg described herein). The leg 1200 is shown as being formed as a combination of three main components, a top portion 1202, a bottom portion 1205 and an LED strip 1206. During assembly of the leg 1200, the top portion 1202 may be secured to the bottom portion 1205 (using a mechanism described below). The LED strip 1206 may be provided between the top portion 1202 and the bottom portion 1205. The top portion 1202 may also include a transparent or semi-transparent portion 1203 such that the light emitted by the LEDs in the LED strip 1206 is visible through the outer surface 1204 of the leg 1200. In some instances, the LED strip (or individual LEDs) may instead be disposed on the outer surface 1204 of the leg 1200 (at the top portion 1202 of the leg 1200).

FIG. 12A also shows the spring-loaded mechanism 1208 that is configured to “auto-deploy” the leg 1200 (or any other leg described herein). That is, the spring-loaded mechanism 1208 causes the leg 1200 to automatically rotate outwardly away from the central member (not shown in the figure) of the portable beacon 200 about the hinge mechanism 1214 (which may be the same as, or similar to, any other hinge mechanism described herein or otherwise). To secure the spring-loaded mechanism 1208 to the leg 1200, the spring-loaded mechanism 1208 may also include an aperture 1209 that is also configured to receive a fastener 1211. Both the top portion 1202 and the bottom portion 1205 of the leg 1200 may include screw bosses (for example, the perspective in FIG. 12A shows the screw boss 1210 on the bottom portion 1205 of the leg 1200, however, the corresponding screw boss on the top portion 1202 of the leg 1200 is not visible) that may also be configured to receive the fastener 1211. Thus, in some embodiments, to secure the spring-loaded mechanism 1208 to the bottom portion 1205 of the leg 1200, and also to secure the bottom portion of the leg 205 to the top portion 1202 of the leg 1200, the fastener 1211 may be inserted into the aperture 1209 in the spring-loaded mechanism 1208, and through corresponding apertures in the screw boss 1210 on the bottom portion 1205 of the leg 1200, and the screw boss on the top portion 1202 of the leg 1200. This is merely one exemplary manner by which the spring-loaded mechanism 1208 may be secured to the bottom portion 1205 of the leg 1200 and the bottom portion 1205 of the leg 1200 may be secured to the top portion 1202 of the leg 1200, and this may be accomplished in any other suitable manner.

Turning to FIG. 12B, the inner surface 1220 of the leg 1200 is shown. The bottom-up perspective of the leg 1200 shown in FIG. 12B illustrates that the inner surface 1220 may also include a transparent or semi-transparent portion 1223 such that the light emitted by the LEDs in the LED strip 1206 is visible through the inner surface 1220 the leg 1200. Although the figures show one LED strip 1206, in some embodiments, there may be multiple LED strips, one for the outer surface 1204 of the leg 1200, and one for the inner surface 1200 of the leg 1200. In some instances, the LED strip (or individual LEDs) may instead be disposed on the inner surface 1220 of the leg 1200 (at the bottom portion 1205 of the leg 1200). In the bottom-up perspective of FIG. 12B, the additional screw boss 1224 located at the top portion 1202 of the leg 1200 is visible. As described above, the screw boss 1224 at the top portion 1202 of the leg 1200 may be configured to receive the fastener 1211 that is inserted through the aperture 1209 of the spring-loaded mechanism 1208 and the aperture of the screw boss 1210 at the bottom portion 1205 of the leg 1200. FIG. 12B also shows that the top portion 1202 of the leg 1200 may include an additional screw boss 1226 configured to receive another fastener 1228. Although not shown in the figure, the bottom portion 1205 of the leg 1200 may also include a screw boss, such that the fastener 1226 may be inserted through the bottom portion 1205 of the leg 1200 and into the screw boss 1226 at the top portion 1202 of the leg 1200 to provide another location at which the bottom portion 1205 is secured to the top portion 1200. As described above, this mechanism for securing the bottom portion 1205 to the top portion 1202 is merely exemplary and the bottom portion 1205 may be secured to the top portion 1202 in any other suitable manner.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Certain aspects of the disclosure are described above with reference to block and flow diagrams of systems, methods, apparatuses, and/or computer program products according to example embodiments. It will be understood that one or more blocks of the block diagrams and flow diagrams, and combinations of blocks in the block diagrams and the flow diagrams, respectively, may be implemented by execution of computer-executable program instructions. Likewise, some blocks of the block diagrams and flow diagrams may not necessarily need to be performed in the order presented, or may not necessarily need to be performed at all, according to some embodiments. Further, additional components and/or operations beyond those depicted in blocks of the block and/or flow diagrams may be present in certain embodiments.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

We claim:

1. An apparatus comprising:
a central member;
a first leg, a second leg, and a third leg that are affixed to the central member and are configured to automatically rotate relative to the central member to support the apparatus in an upright position when disposed within an environment; and
a plurality of light-emitting elements provided at the first leg, second leg, and third leg.

2. The apparatus of claim 1, further comprising a head assembly that is configured to affix to the central member.

3. The apparatus of claim 2, wherein the head assembly comprises a base that is configured to be affixed to a first end of the central member, and a cap that is configured to be affixed to the base.

4. The apparatus of claim 3, wherein the base includes a first aperture and the cap includes a second aperture, and wherein the first aperture and second aperture are configured to receive a fastener used to secure the base to the cap.

5. The apparatus of claim 3, wherein the central member includes a first aperture and the base includes a second aperture, and wherein the first aperture and second aperture are configured to receive a fastener to secure the base to the central member.

6. The apparatus of claim 2, wherein the first leg comprises a first hinge mechanism located at a first end of the first leg, wherein the head assembly is configured to receive the first hinge mechanism, wherein the first leg is configured to rotate relative to the central member at the first hinge mechanism.

7. The apparatus of claim 6, further comprising a first spring-loaded mechanism that is affixed to an inner surface of the first leg, wherein the first spring-loaded mechanism is configured to cause the first leg to automatically rotate relative to the central member about the first hinge mechanism.

8. The apparatus of claim 7, wherein the first leg includes a first portion that is affixed to a second portion.

9. The apparatus of claim 8, wherein the plurality of light-emitting elements are positioned between the first portion and the second portion, and wherein an outer surface of the first portion includes a transparent or semi-transparent portion configured to allow light emitted from the plurality of light-emitting elements to transmit through the first leg.

10. The apparatus of claim 1, wherein the plurality of light-emitting elements are positioned to emit light both from an outer surface of the first leg and an inner surface of the first leg.

11. A portable beacon comprising;
a central member;
a first leg, a second leg, and a third leg that are affixed to the central member and are configured to automatically rotate relative to the central member to support the portable beacon in an upright position when disposed within an environment; and
a plurality of light-emitting elements provided at the first leg, second leg, and third leg.

12. The portable beacon of claim 11, further comprising a head assembly that is configured to affix to the central member.

13. The portable beacon of claim 12, wherein the head assembly comprises a base that is configured to be affixed to a first end of the central member, and a cap that is configured to be affixed to the base.

14. The portable beacon of claim 13, wherein the base includes a first aperture and the cap includes a second aperture, and wherein the first aperture and second aperture are configured to receive a fastener used to secure the base to the cap.

15. The portable beacon of claim 13, wherein the central member includes a first aperture and the base includes a second aperture, and wherein the first aperture and second aperture are configured to receive a fastener to secure the base to the central member.

16. The portable beacon of claim 12, wherein the first leg comprises a first hinge mechanism located at a first end of the first leg, wherein the head assembly is configured to receive the first hinge mechanism, wherein the first leg is configured to rotate relative to the central member at the first hinge mechanism.

17. The portable beacon of claim 16, further comprising a first spring-loaded mechanism that is affixed to an inner surface of the first leg, wherein the first spring-loaded mechanism is configured to cause the first leg to automatically rotate relative to the central member about the first hinge mechanism.

18. The portable beacon of claim 17, wherein the first leg includes a first portion that is affixed to a second portion.

19. The portable beacon of claim 18, wherein the plurality of light-emitting elements are positioned between the first portion and the second portion, and wherein an outer surface of the first portion includes a transparent or semi-transparent portion configured to allow light emitted from the plurality of light-emitting elements to transmit through the first leg.

20. An apparatus comprising:
a central member;
a first leg, a second leg, and a third leg that are affixed to the central member and are configured to automatically rotate relative to the central member about a hinge mechanism of each of the first leg, second leg, and third leg, wherein the first leg, second leg, and third leg are configured to support the apparatus in an upright position when disposed within an environment; and
a plurality of light-emitting elements provided at the first leg, second leg, and third leg, wherein the first leg, second leg, and third leg are configured for light transmission through at least one of: an outer surface or an inner surface of the first leg, second leg, and third leg.
